(19) United States
(12) Patent Application Publication
(10) Pub. No.: US 2018/0046631 A1
(43) Pub. Date: Feb. 15, 2018

(54) DISPLAY APPARATUS AND METHOD FOR CONTROLLING THE SAME

(71) Applicant: SAMSUNG ELECTRONICS CO., LTD., Suwon-si (KR)

(72) Inventor: Woo-sub CHOI, Suwon-si (KR)

(73) Assignee: SAMSUNG ELECTRONICS CO., LTD., Suwon-si (KR)

(21) Appl. No.: 15/661,475

(22) Filed: Jul. 27, 2017

(30) Foreign Application Priority Data
Aug. 9, 2016 (KR) 10-2016-0101217

(51) Int. Cl. G06F 17/30; G06K 9/46

(52) U.S. Cl. CPC G06F 17/3079; G06K 9/4604; G06F 17/30864; G06F 17/3084

(57) ABSTRACT

A display apparatus and a method for controlling the same are provided. The display apparatus includes a display configured to display a video content, a communication interface configured to communicate with a server, a storage, and a processor configured to extract one or more images of an object from each of a plurality of frames of the video content and store the one or more images in the storage. In response to the object included in a displayed screen being selected, the processor transmits the one or more images of the object to the server, receives, from the server, a search result on the object based on the one or more images from the server, and displays the search result on the display.

### CROSS-REFERENCE TO RELATED APPLICATION

This application claims priority from Korean Patent Application No. 10-2016-0101217, filed on Aug. 9, 2016, in the Korean Intellectual Property Office, the disclosure of which is incorporated herein by reference in its entirety.

### BACKGROUND

### 1. Field

The present general inventive concept generally relates to a display apparatus and a method for controlling the same, and more particularly, to a display apparatus that displays information on an object included in a content and a method for controlling the same.

### 2. Description of the Related Art

With the advancement of electronic technologies, electronic apparatuses have diversified in their functions. By way of example, a conventional display apparatus (e.g., a television (TV)) may receive and display content. However, a more recently developed display apparatus is capable of providing more functionalities. As an example, a display apparatus may play back a video and display digital photos stored in a storage device. Further, the display apparatus may display a web page or search for a keyword specified by a user and display a search result based on an Internet connection.

When the user wants to search for a certain keyword using the display apparatus, the user may open up a web page and input text or a voice. When the user knows the correct search term, the display apparatus may display a search result matched with the search query. However, the user may not know the correct search term for what the user wants to search, for example, an object shown in a scene of a television show. As an example, when the user is interested in a bag shown in a scene of a television show but does not have any information to use for a search, it is difficult for the user to search for information on the desired bag by using the existing text input method or voice input method. Accordingly, there is a need for a way to search for an object without having any specific information on the object.

### SUMMARY

The present disclosure has been provided to address the aforementioned and other problems and disadvantages occurring in the related art, and an aspect of the present disclosure provides a display apparatus that is capable of easily and precisely searching for information on an object included in a content and a method for controlling the same.

According to an aspect of an exemplary embodiment, there is provided a display apparatus. The display apparatus includes a display configured to display a video content, a communication interface configured to communicate with a server, a storage, and a processor configured to extract one or more images of an object from each of a plurality of frames of the video content and store the one or more images in the storage. The processor is further configured to, in response to the object included in a displayed screen being selected, transmit the one or more images of the object to the server, receive, from the server, a search result on the object based on the one or more images, and display the search result on the display.

According to an aspect of an exemplary embodiment, there is provided a method for controlling a display apparatus. The method includes extracting one or more images of an object from each of a plurality of frames of a video content, storing the one or more images in a storage, transmitting, in response to the object included in a displayed screen being selected, the one or more images of the object to a server, receiving, from the server, a search result on the object based on the one or more images, and displaying the search result.

According to the above-described various embodiments, the display apparatus and the method for controlling the same may easily select an object to search from a content and acquire a precise search result.

The display apparatus and the method thereof may search for information on the object precisely by using a plurality of images of the object.

The display apparatus and the method thereof may search for the information on the object precisely by using additional information.

The display apparatus and the method thereof may transmit only the images of the object to a server thereby reducing a load of transmission data.

The display apparatus and the method thereof may delete extracted images based on a certain criterion thereby freeing up space in the storage.

Further, The display apparatus and the method thereof may extract an object included in the content and search for the object precisely even after the playback of the content is finished.

### BRIEF DESCRIPTION OF DRAWINGS

The above and/or other aspects will be more apparent by describing the exemplary embodiments with reference to the accompanying drawings, in which:

FIG. 1 is a diagram illustrating a search system according to an exemplary embodiment;

FIG. 2 is a block diagram illustrating a structure of a display apparatus according to an exemplary embodiment;

FIG. 3 is a block diagram illustrating a detailed structure of a processor according to an exemplary embodiment;

FIG. 4 is a diagram provided to describe an operation of extracting an object according to an exemplary embodiment;

FIG. 5 is a diagram provided to describe an operation of storing extracted images of an object according to an exemplary embodiment;

FIG. 6 is a diagram provided to describe an operation of managing stored object images according to an exemplary embodiment;

FIG. 7 is a diagram provided to describe an operation of selecting an object according to an exemplary embodiment;

FIG. 8 is a diagram provided to describe an operation of displaying search information on an object according to an exemplary embodiment;

FIG. 9 is a flowchart provided to describe a method for controlling a display apparatus according to an exemplary embodiment; and

FIG. 10 is a flowchart provided to describe a method for controlling a display apparatus according to an exemplary embodiment.

### DETAILED DESCRIPTION

Reference will now be made in detail to exemplary embodiments with reference to the accompanying drawings. The present disclosure may have several embodiments, and many alternatives, modifications, and variations may be applied to the embodiments. In the following description, certain embodiments are illustrated and described in detail in the accompanying drawings and the detailed description. However, it should be noted that the embodiments do not limit the scope of the present disclosure to any particular embodiment and include all modifications, equivalents, and/or replacements that belong to the range of a technical concept and a technical scope disclosed herein. When it is determined that a detailed description on a publicly-known related art may obscure the gist of the present disclosure unnecessarily, the detailed description will be omitted.

In the following description, a term including an ordinal, for example, “first” or “second,” may be used to distinguish elements, but the elements are not limited by the ordinal. The ordinal is used to only distinguish the same or similar elements. A term in a singular form includes a plural form unless it is explicitly stated otherwise.

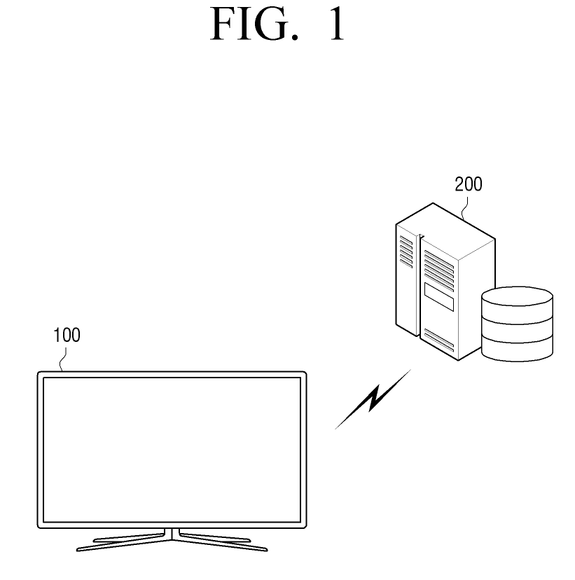

FIG. 1 is a diagram illustrating a search system according to an exemplary embodiment.

The search system includes a display apparatus 100 and a server 200. By way of example, the display apparatus 100 may be a digital TV, a digital broadcasting terminal device, a desktop computer, a slate Personal Computer (PC), a tablet PC, a laptop computer, a mobile phone, a smart phone, a kiosk, digital signage, or the like. The display apparatus 100 may play back a video content. The video content may be a broadcast content provided through a broadcast channel, a digital file, streamed media, etc. A display of the display apparatus 100 may display an image of the video content. For example, the video content may be a broadcast content received from a broadcasting station or a content stored in an internal and/or external storage of the display apparatus 100.

The display apparatus 100 may extract images of an object included in the content at predetermined time intervals while playing back the video content. By way of example, the object included in the content may include a commodity object in one image frame, such as, a car, a bag, or clothes, or may include a background object, such as a tree or a building. According to an embodiment, the display apparatus 100 may extract the images of the object at a specific interval in time such as 5 seconds, 10 seconds, or 1 minute. Further, the display apparatus 100 may extract the images of the object in frames, for example, 10 frames, 30 frames, or 100 frames. The display apparatus 100 may extract the images of the object based on when the object was displayed in a display module. Further, the display apparatus 100 may determine the object based on a data value of a video image processed by a processor and extract the images of the object regardless of when the object was displayed.

The display apparatus 100 may group and store the extracted images of the object for each object. Further, the display apparatus 100 may receive from a user a command to select an object while playing back the video content. As an example, the display apparatus 100 may display a screen including Car ‘A’, Bag ‘B’, and Bicycle ‘C’ while playing back the video content. The user may have an interest in Bag ‘B’ displayed in the screen but only recognize Bag ‘B’ as a bag without knowing the details about the bag, such as a brand, a name, a universal product code (UPC), a price, a vendor, etc.

Conventionally, the user may perform a search with a search term “bag” or with another word that is likely to relate to the bag displayed on the screen. In this case, the search term may be too generic or have nothing to do with Bag ‘B’ displayed on the screen, and in this case, the user may fail to obtain more information on Bag ‘B’ because the search term used (e.g., “bag”) is not specific enough.

However, the display apparatus 100 according to an embodiment may extract and store the images of the object included in the content regardless of the user's selection of the object. According to an embodiment, the display apparatus 100 may extract and store the images of Bag ‘B’. In response to the user being interested in Bag ‘B’ displayed in the screen, the display apparatus 100 may receive a command from the user to select Bag ‘B’. Subsequently, the display apparatus 100 may transmit the stored image of the selected Bag ‘B’ to the server 200. The transmitted images may be a plurality of images.

The server 200 may receive the plurality of images of Bag ‘B’ from the display apparatus 100. The server 200 may perform a search based on the received images. The server 200 may perform the search based on the plurality of images of Bag ‘B’ including images of various sizes and shapes, and thus, the server 200 may be able to search for information on Bag ‘B’ more precisely. The server 200 may transmit the search results on Bag ‘B’ to the display apparatus 100. The display apparatus 100 may display the information received from the server 200.

The user may search for information on the object included in the video content after the playback of the video content is finished. The display apparatus 100 may delete the extracted images according to a certain criterion to free up a storage space. Accordingly, a few or no extracted images may remain after the playback of the video content is finished. Accordingly, the display apparatus 100 may capture an entire area of the frame of the video content at a certain interval separately from the operation of extracting the images of the object. By way of example, the interval may be measured in time, for example, 5 seconds, 10 seconds, or 1 minute, or may be measured in frames, for example, 30 frames, 100 frames, or 1,000 frames. The operation of capturing the frame of the video content may be an operation of capturing a displayed screen based on when the content was displayed or may be operation of storing frame data from a received image signal regardless of a displaying operation. The display apparatus 100 may display a thumbnail image of the captured (or stored) frame in response to the command to select an object. Further, the display apparatus 100 may enlarge the selected thumbnail in response to a command to select a thumbnail image. The display apparatus 100 may extract the images of the object selected in response to the command to select the object included in the enlarged thumbnail and transmit the extracted images to the server 200. The server 200 may perform the search based on the transmitted images of the objects and transmit the search results on the object to the display apparatus 100. The display apparatus 100 may display the received information (e.g., search results).

As described above, the display apparatus 100 performs the search by using the object in the displayed screen. Accordingly, the display apparatus 100 may search for the information precisely even when the user does not know exactly what the object is. Hereinafter, a detailed description on the components of the display apparatus 100 will be provided.

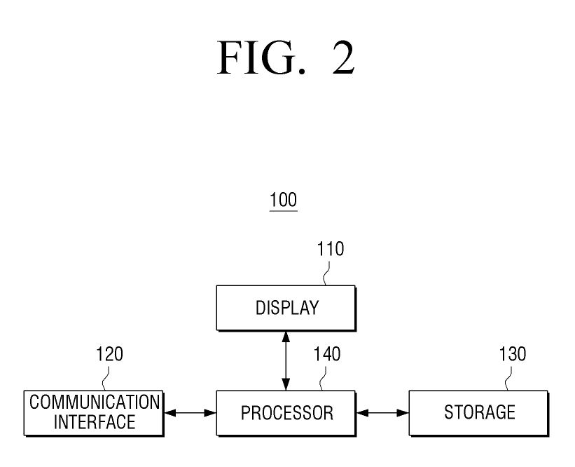

FIG. 2 is a block diagram illustrating a structure of a display apparatus according to an exemplary embodiment.

Referring to FIG. 2, the display apparatus 100 includes a display 110, a communication interface 120, a storage 130, and a processor 140. The display 110 may play back a video content. For example, the display 110 may be a liquid crystal display (LCD), a thin-film transistor LCD (TFT-LCD), an organic light emitting diode (OLED), a flexible display, an electronic ink display, or the like. The display 110 may include a touch sensor. Further, the display 110 may be implemented as a single device with the touch sensor or may be implemented as a touch screen that forms a layer structure with the touch sensor. The display 110 implemented as the touch screen may function as an input interface and an output interface between the display apparatus 110 and the user.

The communication interface 120 may communicate with a server. The communication interface 120 may transmit the extracted images of the object to the server and receive the searched information on the object from the server. Further, the communication interface 120 may receive a broadcast signal and information related to the broadcasting from an external broadcasting server (or a broadcasting station) through a broadcast channel. The communication interface 120 may include an external input terminal and receive a video content stored in an external storage through the external input terminal.

The storage 130 stores data for supporting diverse functions of the display apparatus 100. The storage 130 may store software for operations of the display apparatus 100 and may store input/output data. Further, the storage 130 may store the images of the object extracted from the frames of the video content. For example, the storage 130 may include at least one type of storage medium among flash memory, hard disk drive (HDD), solid-state drive (SSD), multimedia card micro, random access memory (RAM), static RAM (SRAM), read-only memory (ROM), electrically erasable and programmable ROM (EEPROM), programmable ROM (PROM), magnetic memory, magnetic disc, and optical disc.

The processor 140 extracts the images of the object from each of the plurality of frames of the video content. According to an embodiment, the processor 140 may extract the images of the object at predetermined intervals. To be specific, the processor 140 may extract the images of the object at intervals in time, for example, 3 seconds, 15 seconds, or 1 minute, or may extract the images at intervals in frames, for example, 30 frames, 100 frames, or 1,000 frames. Further, the processor 140 may extract the images of a plurality objects included in one frame. As an example, in response to a frame including a car, a tree, a necktie, and a bag, the processor 140 may extract the images of the car, the tree, the necktie, and the bag. The processor 140 may distinguish an object from the background based on an edge (e.g., outline) of the object and extract the images of the object.

The processor 140 may store the extracted images of the object in the storage 130. The processor 140 may extract a plurality of images corresponding to the object from each of the plurality of frames. For example, in response to the processor 140 extracting the images of the object on a 30-frame basis (e.g., every 30 seconds), the processor 140 may extract a side-view image of Car ‘A’ included in the 30th frame, extract an enlarged image of Car ‘A’ included in the 60th frame, and extract a front-view image of Car ‘A’ included in the 90th frame. The processor 140 may group the plurality of extracted image for each object and store the images in the storage 130. In the above example, the processor 140 may generate a group of Car ‘A’ and store the extracted side-view, enlarged, and front-view images of Car ‘A’ in the storage 130. Further, the processor 140 may store the images in the storage 130 along with an extracted time of the images (e.g., a timestamp representing the temporal location of an extracted image within the video content), channel information on the video content, input signal information on the video content, and metadata.

The user may select the object displayed in the screen while the video content is played back. The processor 140 may determine the selected object. To be specific, the processor 140 may determine that Car ‘A’ included in the displayed screen of the video content was selected. The processor 140 may control the communication interface 120 to transmit the stored images of the object to the server. The processor 140 may control the communication interface 120 to transmit a part of the images included in a selected object group, entire images in the selected object group, or the selected object group itself to the server according to a certain criterion. In response to the information, such as, the extracted time of the images, the channel information on the video content, the input signal information on the video content, and the metadata, being added to the images of the object, the communication interface 120 may transmit the added information to the server along with the images.

The server may receive the group including the images of the object or one or more images of the object from the display apparatus 100. The server may search for the information related to the object using the received images of the object. The images of the object received from the server may include the additional information, such as, the extracted time of the images, the channel information on the video content, the input signal information on the video content, and the metadata. The server may search for the information on the object using the received images and the additional information. In this case, the server may acquire more precise a search result. According to an embodiment, the server may receive additional information about the images of Car ‘A’, such as a broadcast station (e.g., ‘BBB’), a television channel (e.g., ‘CCC’), a television show (e.g., ‘DD’), and a timestamp (e.g., at 20:38 mark within the video), and the server may recognize that the object is Car ‘A’ and search for information on Car ‘A’ more efficiently. The server may transmit the information on the searched object (e.g., search results) to the display apparatus 100.

The processor 140 may control the communication interface 120 to receive the information on the object searched based on the transmitted images of the object from the server. The processor 140 may control the display 110 to display the received information on the object.

The display apparatus may include an input interface. The input interface may receive various commands from the user. To be specific, the input interface may receive the commands, such as, a command to move a pointer, a command to select an object, a command to display a stored thumbnail image, a command to select a thumbnail image, a command to search for information on an object, or the like. For example, the input interface may include a remote controller, a mouse, a touch screen, a keyboard, a keypad, or a camera for receiving an image signal of a user gesture.

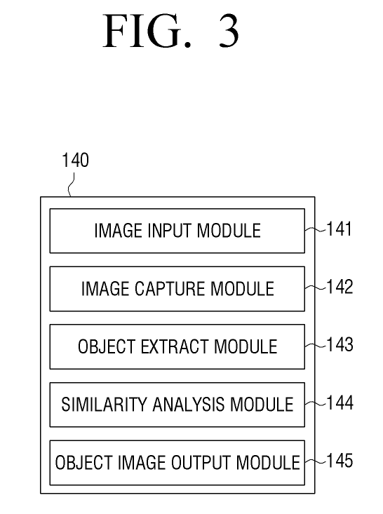

FIG. 3 is a block diagram illustrating a detailed structure of a processor according to an exemplary embodiment.

Referring to FIG. 3, the processor 140 may include an image input module 141, an image capture module 142, an object extract module 143, a similarity analysis module 144, and an object image output module 145. The various modules illustrated in FIG. 3 and other figures may be implemented with software, hardware, or a combination of both.

The image input module 141 may receive the frames of the video content. The video content may be received through the communication interface or may be stored in the storage and received from the storage.

The image capture module 142 may capture the frames of the video content. The image capture module 142 may capture (or store) the video content at predetermined intervals. The frames captured by the image capture module 142 may be used when the user selects an object included in the video content after the playback of the video content is finished.

The object extract module 143 may extract the images of the object included in the frames of the received video content. To be specific, the object extract module 143 may extract the images of the object from a plurality of frames at predetermined intervals. Further, the object extract module 143 may extract a plurality of images of the object included in one frame. The object extract module 142 may extract the images of the object selected by the user from the captured frame. According to an embodiment, the object extract module 143 may recognize an area based on a border line (e.g., an outline or a silhouette), or a color of the object and extract the recognized area as the image of the object. The method for recognizing an object in a frame is well known, and thus, a detailed description will be omitted.

The similarity analysis module 144 may analyze the similarity of the extracted images. As described above, the object extract module 143 may extract the images of the object from the plurality of frames at predetermined intervals. Accordingly, the plurality of images of the same object may be extracted. The similarity analysis module 144 may determine the similarity between the currently extracted images and the previously extracted images. According to an embodiment, the similarity of the images may be determined by the operations described below. The similarity analysis module 144 extracts features from the images, perform clustering with respect to the extracted features, and extract codewords. Subsequently, the similarity analysis module 144 generates a codebook including the extracted codewords. The similarity analysis module 144 expresses each image as a histogram of the codewords and determine the similarity of the histogram values to determine the similarity of the images. The above-described method is only an example, and the similarity analysis module 144 may determine the similarity of the images in various methods. As an example, in response to the front-view image of Car ‘A’ previously being extracted and the side-view image of Car ‘A’ currently being extracted, the similarity analysis module 144 may determine that the previously extracted front-view image and the currently extracted side-view image are of the same object according to various methods for determining the similarity of the images.

The object image output module 145 may output the currently extracted images to the storage so as to be stored in the same object group in the storage. Further, the object image output module 145 may output the extracted images to the communication interface so as to be transmitted to the server.

The above-described image input module 141, image capture module 142, object extract module 143, similarity analysis module 144, and object image output module 145 of the processor 140 may be realized as any of hardware and software.

Hereinafter, a method for extracting and managing the images of an object will be described in detail.

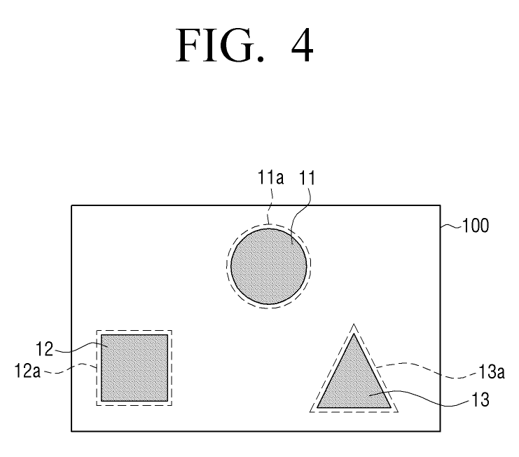

FIG. 4 is a diagram provided to describe an operation of extracting an object according to an exemplary embodiment.

FIG. 4 illustrates an example of a display apparatus 100 that displays a plurality of objects 11, 12, 13. The display apparatus 100 may display the frames of a video content sequentially. The display apparatus 100 may extract the images of an object included in the frames of the video content at predetermined intervals. The display apparatus 100 may extract the images of the object included in the frames of the video content at predetermined intervals regardless of whether the object is displayed by a display module, or extract the images of the object at predetermined intervals based on when the object is displayed by the display module.

The objects 11, 12, 13 in the frames of the video content may include border line or a color distinguished from a background image or a surrounding image. Accordingly, the display apparatus 100 may extract the images 11a, 12a, 13a of the objects 11, 12, 13 based on the border line or color of the objects 11, 12, 13. The display apparatus 100 may extract the images 11a, 12a, 13a based on the outermost border line or color so that the objects 11, 12, 13 are preserved. In this case, the extracted images 11a, 12a, 13a may be bigger than the actual objects to a certain degree. Further, the display apparatus 100 may extract the images 11a, 12a, 13a based on a boundary pixel of the color or a pixel on an average point in a border line area of the objects 11, 12, 13. In this case, the extracted images 11a, 12a, 13a may be the same in size as the actual objects.

The display apparatus 100 may store the extracted images of the object in the storage. In response to extracting the images of the object selected in the enlarged thumbnail image, the display apparatus 100 may transmit the extracted images of the object to the sever through the communication interface.

The display apparatus 100 may receive information from the user on a size or the number of objects to extract. The size of an object may be set on a pixel basis, on a length basis, or on a dimension basis. According to an embodiment, the display apparatus 100 may receive a value such as ‘at least 100 pixels×100 pixels’ from the user. In this case, the display apparatus 100 may extract the images of only the object with at least 100 pixels×100 pixels according to the user input. Further, the display apparatus 100 may receive a value such as ‘five objects’ from the user. In this case, the display apparatus 100 may extract the images of only five objects according to the user input. If extracted images of more than five objects are present, the display apparatus 100 may delete the oldest (e.g., extracted earliest) object group. The aforementioned size and number of objects are only example, and the size and the number of objects may be set to be various values.

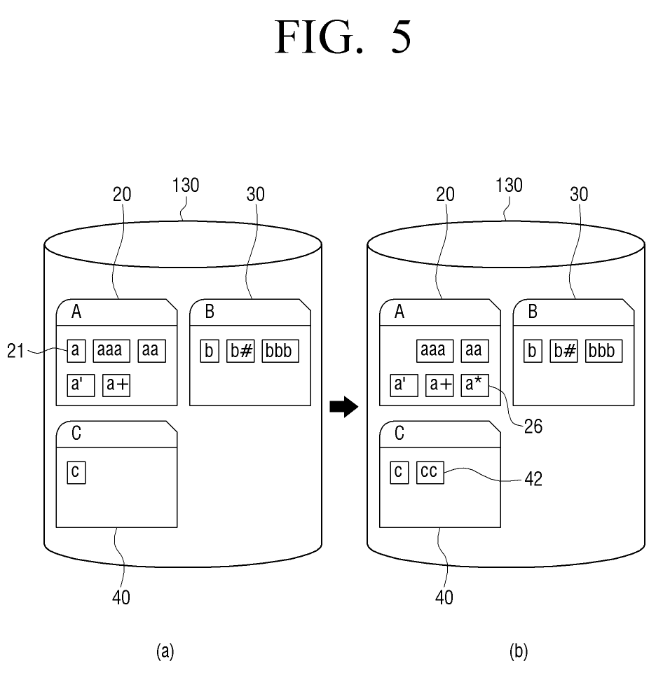

FIG. 5 is a diagram provided to describe an operation of storing extracted images of an object according to an exemplary embodiment.

Drawing (a) of FIG. 5A illustrates an example of the storage 130 where the extracted images have been stored. According to an embodiment, the storage 130 may store the images of Object ‘A’, Object ‘B’, and Object ‘C’. In response to the images being extracted, the storage 130 may generate a group of objects from which the images were extracted. The storage 130 generates Object group ‘A’ 20, Object group ‘B’ 30, and Object group ‘C’ 40 and stores the images for each group. Object group ‘A’ 20 stores five images including Image ‘a’ 21, Object group ‘B’ 30 stores three images, and Object group ‘C’ 40 stores one image. The display apparatus 100 may determine only the similarity of the extracted images without determining the identity of the object. Accordingly, the display apparatus 100 may assign a random number or character, such as the first group or Group ‘A’, to generate an object group.

Drawing (b) of FIG. 5 illustrates an example of the storage 130 after a certain time has elapsed from the point of time of drawing (a) of FIG. 5. The display apparatus 100 extracts the images of the object from a plurality of frames of a video content. The display apparatus 100 may extract a lot of images while playing back the video content. Accordingly, in response to the number of the extracted images exceeding a predetermined number with reference to one object, the display apparatus 100 may delete the pre-stored images by considering the capacity of the storage 130. According to an embodiment, the predetermined number may be set to be five. Object group ‘A’ 20 stores a newly extracted Image ‘a*’ 26. Object group ‘A’ 20 already stores five images before Image ‘a*’ 26 is extracted, and thus, the display apparatus 100 may delete Image ‘a’ 21 that is the oldest and maintain the number of the images to be five. Object group ‘C’ 40 may store a newly extracted Image ‘cc’ 42.

As described above, the display apparatus 100 may set the number of the stored images with reference to an object by considering the capacity of the storage 130. Further, the display apparatus 100 may set the number of the objects to be extracted in the similar manner.

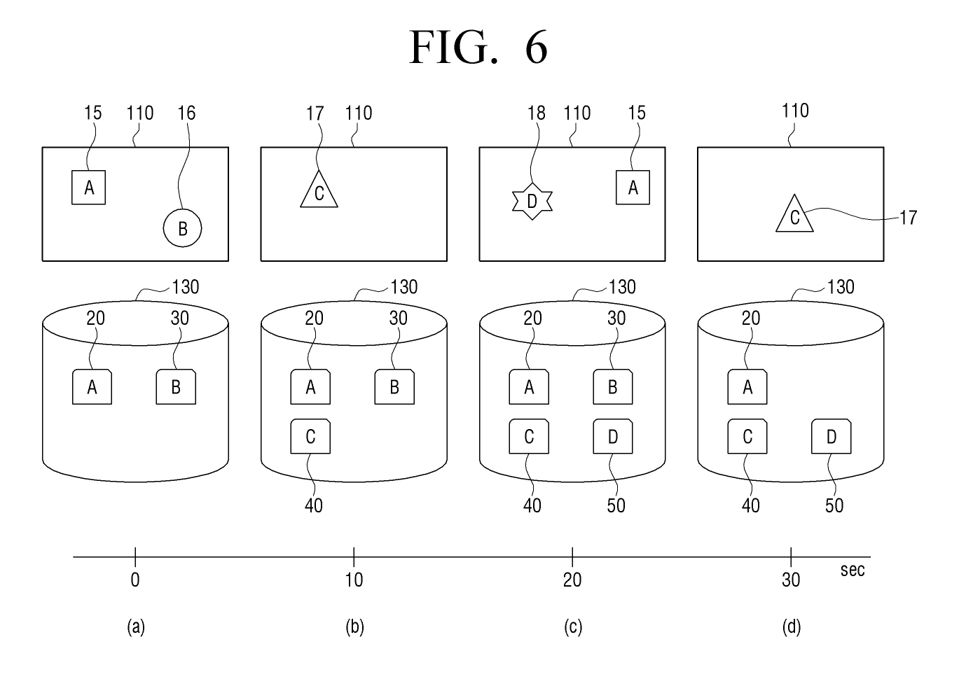

FIG. 6 is a diagram provided to describe an operation of managing stored object images according to an exemplary embodiment.

In response to a predetermined time elapsing from when the object was last displayed in the display 110, the display apparatus 100 may delete the extracted images of the object from the storage 130 by considering the capacity of the storage 130. According to an embodiment, the display apparatus 100 may set the predetermined time interval to be 30 seconds and in response to 30 seconds elapsing from when the object was last displayed in the display 110, the display apparatus 100 may delete the images of the object or the object group. Drawings (a) through (d) of FIG. 6 illustrate the objects displayed over time and stored object groups.

Drawing (a) of FIG. 6 illustrates the displayed objects and the stored object group at a reference time. The display 110 may display Object ‘A’ 15 and Object ‘B’ 16. The display apparatus 100 may extract the images of Object ‘A’ 15 and Object ‘B’ 16, generate Object group ‘A’ 20 and Object group ‘B’ 30, and store the extracted images in each group. Accordingly, the storage 130 may store Object group ‘A’ 20 and Object group ‘B’ 30 including the extracted images.

Drawing (b) of FIG. 6 illustrates the displayed object and the stored object groups after 10 seconds have elapsed from the reference time. The display 110 may display Object ‘C’ 17. The display apparatus 100 may extract the images of Object ‘C’ 17, generate Object group ‘C’ 40, and store the extracted images. Accordingly, the storage 130 may store Object group ‘A’ 20 and Object group ‘B’ 30 along with the newly generated Object group ‘C’ 40.

Drawing (c) of FIG. 6 is a drawing illustrating the displayed objects and the stored object groups after 20 seconds have elapsed from the reference time. The display 110 may display Object ‘A’ 15 and Object ‘D’ 17. The display apparatus 100 may extract the image of Object ‘A’ 15 and store the image in Object group ‘A’ 20 that was previously generated. Further, the display apparatus 100 may extract the image of Object ‘D’ 17, generate Object group ‘D’ 50, and store the extracted images. Accordingly, the storage 130 may store Object group ‘A’ 20, Object group ‘B’ 30, and Object group ‘C’ 40 along with the newly generated Object group ‘D’ 50.

Drawing (d) of FIG. 6 illustrates the displayed object and the stored object groups after 30 seconds have elapsed from the reference time. The display 110 may display Object ‘C’ 17. The display apparatus 100 may extract the image of Object ‘C’ 17 and store the image in Object group ‘C’ 40 that was previously generated. As described above, the display apparatus 100 may set the time for deleting the object images to be 30 seconds. In this example, 10 seconds have elapsed from when Object ‘A’ 15 and Object ‘D’ 17 were last displayed, and 30 seconds have elapsed from when Object ‘B’ 16 was last displayed. In this case, the display apparatus 100 may delete Object group ‘B’ 30 stored in the storage 130. Accordingly, the storage 130 may store Object group ‘A’ 20, Object group ‘C’ 40, and Object group ‘D’ 50.

In FIG. 6, the extracted images of the object are deleted in response to the predetermined time elapsing from when the object was last displayed in the display 110. However, the display apparatus 100 may delete the stored images of the object or object group in response to a predetermined number of frames exceeding from the last frame including the object. This embodiment where the display apparatus 100 deletes the images of the object based on a frame is similar to the embodiment where the display apparatus 100 deletes the images of the object based on time described above in FIG. 6, and thus, a detailed description on this embodiment will be omitted.

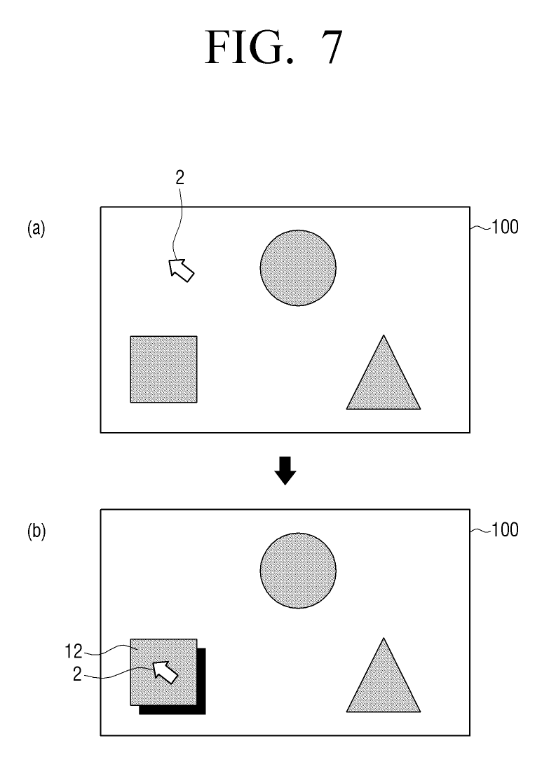

FIG. 7 is a diagram provided to describe an operation of selecting an object according to an exemplary embodiment.

Drawing (a) of FIG. 7 illustrates an example of the display apparatus 100 where the objects are displayed. The display apparatus 100 may display the frame of the video content. The displayed frame may include one or more objects. The display apparatus 100 may display a pointer 2 moving in response to a user command. That is, the pointer 2 displayed in the display apparatus 100 may be moved according to a user input. For example, the display apparatus 100 may perceive a motion of a user gesture and move the pointer 2 in response to the user gesture. Further, the display apparatus 100 may move the pointer 2 in response to a button input or a movement of a remote control or a mouse. In case of the display apparatus 100 with a touch screen, the display apparatus 100 may move the pointer 2 in response to a touch gesture or a movement gesture that is input through the touch screen. The user may move the pointer 2 onto one object among the displayed objects.

Drawing (b) of FIG. 7 illustrates an example of the display apparatus 100 where an object has been selected. The display apparatus 100 may move the pointer 2 onto an object 12 according to the user input. When the pointer 2 is moved onto the object 12, the display apparatus 100 may apply a visual effect to the object 12 where the pointer 2 is located. The visual effect may include highlight, pop-up, displaying a border line, or changing color, for example. In response to receiving a command to select an object (e.g., a button press) while the pointer 2 is located on the object 12, the display apparatus 100 may select the object 12 and transmit the images included in the group of the selected object 12 to the server.

The display apparatus 100 may transmit the entire images included in the group corresponding to the selected object 12 or transmit the group itself. As the display apparatus 100 transmits the plurality of images to the server, the server may determine the object more precisely and reduce errors in searching for relevant information. Further, the display apparatus 100 may select an image that satisfies a predetermined search condition from among the images included in the group of the selected object 12 and transmit the selected image to the server. For example, the predetermined search condition may include a size, a histogram, complexity of a border line, and internal complexity of an image. The server may determine the object more precisely based on a large image rather than a small image. The server may determine the object more precisely when the histograms of the images are much different from each other rather than being similar to each other. Further, the server may determine the object more precisely based on an image with low complexity of a border line or an image with low internal complexity. The above-described size, histogram, complexity of a border line, or internal complexity of an image may be classified by an absolute numerical value or ratio. The display apparatus 100 may select one numerical value or ratio from among the classified absolute numerical values or ratios to set the search condition. Further, the display apparatus 100 may select some images from among the plurality of images included in the selected objects 12 according to the above-described conditions and transmit the selected images to the server. Accordingly, the search system in the embodiments disclosed herein may reduce a load of the transmission data, enhance accuracy and speed in determining an object, and increase preciseness of the searched information.

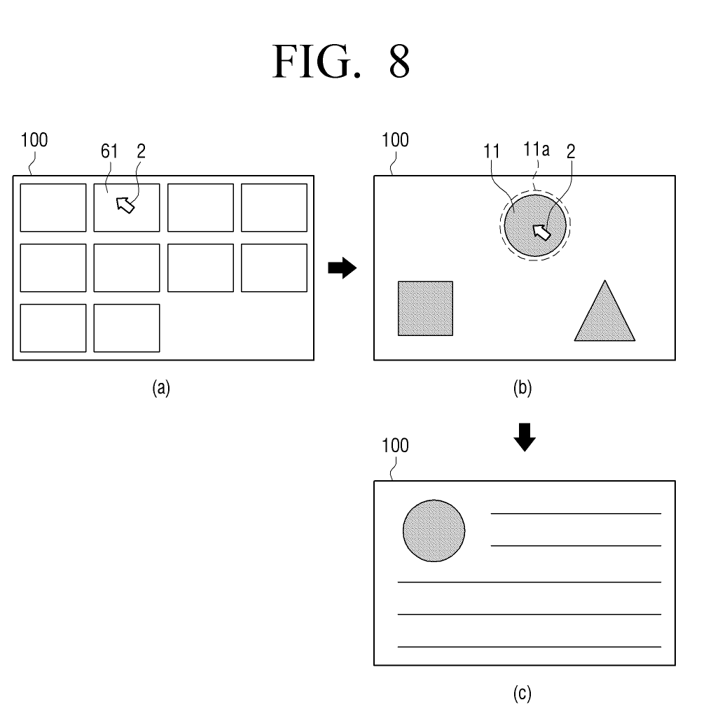

FIG. 8 is a diagram provided to describe an operation of displaying search information on an object according to an exemplary embodiment. The user may search for information on the object included in the frames of the video content after the playback of the video contents is finished.

Drawing (a) of FIG. 8 illustrates an example of the display apparatus 100 where thumbnail images of the stored frames are displayed. As described above, the display apparatus 100 may store the entire area of the frames of the video content at predetermined intervals. The display apparatus 100 may store the frame data at predetermined intervals regardless of whether the inputted video content is displayed or may capture and store the entire area of the frames based on when the frames are displayed. For example, the predetermined interval may be set in frames, for example, 30 frames, 100 frames, or 300 frames or may be set in time durations, for example, 3 seconds, 1 minute, and 5 minutes. Accordingly, in response to the playback of the video content being finished, the display apparatus 100 may store a plurality of frames.

After the playback of the video content is finished, the display apparatus 100 may display the plurality of stored frames as the thumbnail images in response to a command to display the stored frames. The display apparatus 100 may display the pointer 2 for selecting a thumbnail image along with the thumbnail images. The user may move the pointer 2 onto a thumbnail 61 among the plurality of displayed thumbnail images and input a command to select the thumbnail image 61.

The display apparatus 100 may display a visual effect on the thumbnail image 61 where the pointer 2 is located. The visual effect may include highlight, pop-up, displaying a border line, or changing a color, for example.

Drawing (b) of FIG. 8 illustrates an example of the display apparatus 100 where an object included in an enlarged thumbnail image is selected. In response to the thumbnail image 61 being selected, the display apparatus 100 may enlarge the selected thumbnail image 61. The display apparatus 100 may display the selected thumbnail image 61 in a predetermined area and display other thumbnail images in other areas. Further, the display apparatus 100 may display the selected thumbnail image 61 in the entire area. The user may move the displayed pointer 2 so as to be located on an object 11 included in the frame and input a command to select the object. The display apparatus 100 may extract an image 11a of the object 11 where the pointer 2 is located in response to the command. Subsequently, the display apparatus 100 may transmit the extracted image 11a to the server. The server may receive the image 11a from the display apparatus 100 and search for relevant information. The server may transmit the searched information to the display apparatus 100.

Drawing (c) of FIG. 8 illustrates an example of the display apparatus 100 where the searched information is displayed. The display apparatus 100 may receive the searched information on the object from the server. The display apparatus 100 may display the received information.

So far, various embodiments of extracting the images from the video content, searching for the relevant information, and displaying the searched information have been provided. Hereinafter, a method for controlling a display apparatus will be described.

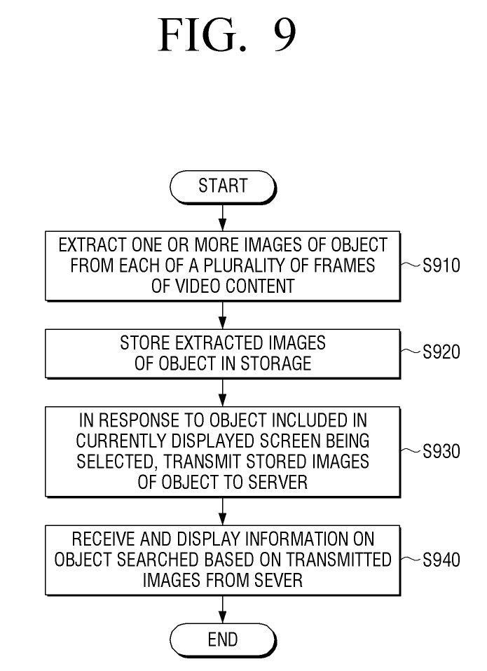

FIG. 9 is a flowchart provided to describe a method for controlling a display apparatus according to an exemplary embodiment.

Referring to FIG. 9, a display apparatus may extract one or more images of an object from each of a plurality of frames of a video content (S910). In response to receiving information on a size and the number of the object, the display apparatus may extract the images of the object from the video content.

The display apparatus may store the extracted images of the object in a storage (S920). The display apparatus may group and store the plurality of images corresponding to the object extracted from each of the plurality of frames for each object. The display apparatus may store the extracted images along with at least one of an extracted time of the images, channel information on the video content, input signal information on the video content, and metadata. The display apparatus may transmit the images to the server along with the additional information. The server may easily determine the object and search for information related to the object by using the received images and additional information.

In response to a predetermined time elapsing from when the object was last displayed in a display, the display apparatus may delete the extracted images of the object from the storage. In response to the number of the extracted images exceeding a predetermined number, the display apparatus may delete some of the stored images from the storage.

In response to the object included in a currently displayed screen being selected, the display apparatus may transmit the stored images of the object to the server (S930). The display apparatus may transmit one or more images included in a group corresponding to the object selected in the displayed screen to the server. Further, the display apparatus may select an image that satisfies a predetermined search condition from among the plurality of images included in the group corresponding to the object and transmit the selected image to the server. The predetermined search condition may be at least one of a size, a histogram, complexity of a border line, and internal complexity of an image.

The display apparatus may receive and display the information on the object searched based on the transmitted images from the sever (S940). Accordingly, the user may easily acquire the information on the object even if the user does not exactly know the object.

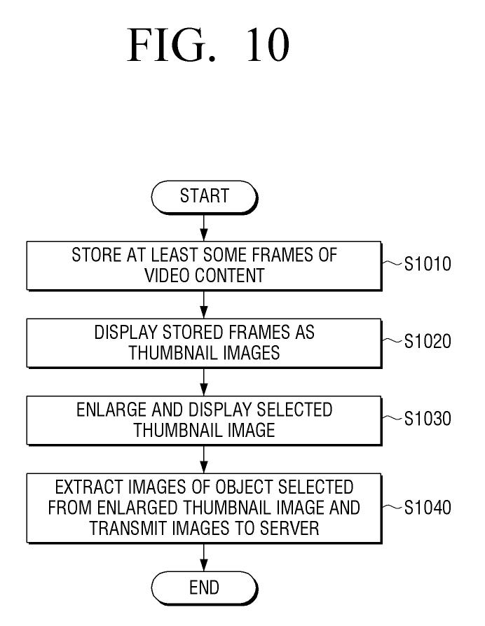

FIG. 10 is a flowchart provided to describe a method for controlling a display apparatus according to an exemplary embodiment.

Referring to FIG. 10, the display apparatus may store at least some frames of a video content (S1010). The display apparatus may store the frames of the video content regardless of whether the frame is displayed or may store the frames of the video content based on when the frame is displayed.

The display apparatus may display some stored frames as the thumbnail images (S1020). The display apparatus may display the plurality of stored frames as the thumbnail images according to a user command. The display apparatus may receive a command to select a thumbnail image from among the plurality of thumbnail images. The display apparatus may enlarge and display the selected thumbnail image (S1030). The display apparatus may receive a command to select an object included in the enlarged thumbnail image. The display apparatus may extract the images of the object selected from the enlarged thumbnail image and transmit the images to the server (S1040). The server may perform a search based on the received images and transmit the searched information to the display apparatus. The display apparatus may display the information received from the server.

As an example, the method for controlling a display apparatus according to above-described embodiments may be implemented as a program and provided through a non-transitory computer readable medium.

A non-transitory computer-readable medium may store computer instructions which cause the apparatus to perform operations when executed by a processor of an apparatus.

The non-transitory computer readable medium does not mean a medium storing data for a short period such as a register, a cash, a memory, or the like, but means a machine-readable medium semi-permanently storing the data. Specifically, various applications or programs described above may be stored and provided in the non-transitory computer readable medium such as a compact disc (CD), a digital versatile disk (DVD), a hard disk, a Blu-ray disk, a universal serial bus (USB), a memory card, a read-only memory (ROM), or the like.

As above, a few embodiments have been shown and described. The foregoing embodiments and advantages are merely exemplary and are not to be construed as limiting the present disclosure. The present teaching can be readily applied to other types of devices. Also, the description of the embodiments is intended to be illustrative, and not to limit the scope of the claims, and many alternatives, modifications, and variations will be apparent to a person having ordinary skill in the art.

What is claimed is:

1. A display apparatus comprising:
a display configured to display a video content;
a communication interface configured to communicate with a server;
a storage; and
a processor configured to extract one or more images of an object from each of a plurality of frames of the video content and store the one or more images in the storage,
wherein the processor is further configured to, in response to the object included in a displayed screen being selected, transmit the one or more images of the object to the server, receive, from the server, a search result on the object based on the one or more images, and display the search result on the display.

2. The display apparatus as claimed in claim 1, wherein the processor is further configured to group and store the one or more images corresponding to the object, and transmit, to the server, the one or more images included in a group corresponding to the object selected in the displayed screen.

3. The display apparatus as claimed in claim 2, wherein the processor is further configured to select an image that satisfies a predetermined search condition from among the one or more images included in the group corresponding to the object and transmit the selected image to the server.

4. The display apparatus as claimed in claim 3, wherein the predetermined search condition is at least one of a size, a histogram, complexity of a border line, and internal complexity of the image.

5. The display apparatus as claimed in claim 1, wherein the processor is further configured to, in response to a predetermined time elapsing from when the object was last displayed in the display, delete at least one of the one or more images of the object from the storage.

6. The display apparatus as claimed in claim 1, wherein the processor is further configured to, in response to a number of the one or more images exceeding a predetermined number, delete at least one of the one or more images from the storage.

7. The display apparatus as claimed in claim 1, wherein the processor is further configured to store the one or more images in the storage along with at least one of an extracted time of the one or more images, channel information on the video content, input signal information on the video content, and metadata.

8. The display apparatus as claimed in claim 1, wherein the processor is further configured to, in response to receiving information on a size and a number of objects, extract the one or more images of the object from the video content based on the received information.

9. The display apparatus as claimed in claim 1, wherein the processor is further configured to store and display at least some of the plurality of frames of the video content as a thumbnail image, enlarge and display a selected thumbnail image, extract the one or more images of the object selected from the enlarged thumbnail image, and transmit the one or more images to the server.

10. A method for controlling a display apparatus, the method comprising:
extracting one or more images of an object from each of a plurality of frames of a video content;
storing the one or more images in a storage;
transmitting, in response to the object included in a displayed screen being selected, the one or more images of the object to a server;
receiving, from the server, a search result on the object based on the one or more images; and
displaying the search result.

11. The method as claimed in claim 10, wherein the storing comprises grouping and storing the one or more images corresponding to the object, and
wherein the transmitting comprises transmitting, to the server, the one or more images included in a group corresponding to the object selected in the displayed screen.

12. The method as claimed in claim 11, wherein the transmitting comprises selecting an image that satisfies a predetermined search condition from among the one or more images included in the group corresponding to the object and transmitting the selected image to the server.

13. The method as claimed in claim 12, wherein the predetermined search condition is at least one of a size, a histogram, complexity of a border line, and internal complexity of the image.

14. The method as claimed in claim 10, further comprising:
in response to a predetermined time elapsing from when the object was last displayed in a display, deleting at least one of the one or more images of the object from the storage.

15. The method as claimed in claim 10, further comprising:
in response to a number of the one or more images exceeding a predetermined number, deleting at least one of the one or more images from the storage.

16. The method as claimed in claim 10, wherein the storing comprises storing the one or more images in the storage along with at least one of an extracted time of the one or more images, channel information on the video content, input signal information on the video content, and metadata.

17. The method as claimed in claim 10, wherein the extracting comprises, in response to receiving information on a size and a number of objects, extracting the one or more images of the object from the video content based on the received information.

18. The method as claimed in claim 10, further comprising:
storing at least some of the plurality of frames of the video content;
displaying the at least some of the plurality of frames as a thumbnail image;
enlarging and displaying a selected thumbnail image; and
extracting the one or more images of the object selected from the enlarged thumbnail image and transmitting the one or more images to the server.
